(19) United States
(12) Patent Application Publication
(10) Pub. No.: US 2012/0131782 A1
(43) Pub. Date: May 31, 2012

(54) METHOD FOR MAKING A MOULD FOR A WIND TURBINE ROTOR BLADE

(75) Inventor: Leif Kappel Petersen, Lem St. (DK)

(73) Assignee: VESTAS WIND SYSTEMS A/S, Aarhus N (DK)

(21) Appl. No.: 13/386,224

(22) PCT Filed: Jul. 16, 2010
(86) PCT No.: PCT/DK2010/050190

§ 371 Date: Feb. 1, 2012

Related U.S. Application Data
(60) Provisional application No. 61/227,922, filed on Jul. 23, 2009.

(30) Foreign Application Priority Data
Jul. 23, 2009 (DK) PA 2009 70074

(51) Int. Cl. B23Q 17/00

(52) U.S. Cl. 29/407.01

(57) ABSTRACT

A method for making a mould for a part of a wind turbine rotor blade to be moulded in the mould, the method comprises determining whether a geometrical property of the mould is within an acceptable limit; and if the determined geometrical property is not within the acceptable limit adjusting the mould so as to bring the geometrical property to be within the acceptable limit. The mould needs not be manufactured to the final and narrow tolerances required for making wind turbine generator rotor blades, but adjustment to desired geometrical properties can be carried out according to determined geometrical properties and desired tolerances. This ensures that rotor blades can be produced with desired geometrical and aerodynamic properties and with narrow tolerances. Also, the mould can be made lighter whereby it will be less costly and easier to move and to manipulate.

### FIELD OF THE INVENTION

The invention relates to moulds for moulding large objects such a rotor blades for wind turbine generators.

### BACKGROUND OF THE INVENTION

Today's wind turbine generator rotor blades are large structures, and most wind turbine generator rotor blades comprise two half-shells that are assembled along their common edges to form the outer shell of the rotor blade. Each half-shell can be produced as a composite structure comprising e.g. a glass fibre reinforced resin material that is arranged in a mould where the resin is cured.

Aerodynamic properties of a wind turbine generator rotor blade are of great importance to the operation of the rotor blade and of the wind turbine generator. Imperfect aerodynamic properties of rotor blades lead to sub-optimal operation of the wind turbine generator. Aerodynamic properties of a wind turbine generator rotor blade are influenced by its geometrical properties. It is therefore desirable that the geometrical properties of each blade are kept within acceptable limits. Such geometrical properties include cross-sections transverse to a longitudinal axis of the rotor blade.

A mould for moulding a half-shell for a wind turbine generator rotor blade can have the general form of an elongated trough with an upwardly open cavity in which the material to be moulded is placed along the inner surface of the cavity of the mould.

Moulds for moulding blade shells for wind turbine generator rotor blades are made based on complex computer calculations of the ideal form of the blade. Such calculations are based on desired aerodynamic properties of the finished rotor blade and on the many materials and technologies involved in the process of producing the blade. However, even very accurately produced moulds may deviate from the ideal or predefined form. Deviations which are not within acceptable limits result in corresponding deviations in geometrical properties of the moulded blade not being within acceptable limits, which in turn influences the aerodynamic properties correspondingly. It may therefore be seen as an object of the invention to provide a method for making a mould for a part of a wind turbine rotor blade where it is ensured that its geometrical properties are brought within acceptable limits and thereby to ensure that the rotor blades produced by the mould have the desired uniform and consistent aerodynamic properties.

### SUMMARY OF THE INVENTION

The invention thus provides a method for making a mould for a part of a wind turbine rotor blade to be moulded in the mould, the method comprising
providing a first mould;
determining whether a geometrical property of the first mould and/or a moulded part from the first mould is within an acceptable limit;

and if the determined geometrical property is not within the acceptable limit
adjusting the first mould so as to bring the geometrical property to be within the acceptable limit.

The adjusting of the first mould may be based upon a geometrical property of the first mould and/or a moulded part from the first mould—or in general, upon a geometrical property directly and/or indirectly related the shape of mould.

Generally, large moulded parts such as parts of a wind turbine rotor blade may, after having been removed from the mould, exhibit geometrical properties that deviate from the desired geometrical properties. Such deviations can be due to e.g. residual tensions in the moulded parts that are released subsequent to the moulded part having been removed from the mould and may develop over a period of time. Geometrical properties of such a moulded part may then be determined by measurement, and if desired the mould may be adjusted correspondingly to accommodate for such changes in geometrical properties of the moulded parts.

Thus, instead of, or in addition to, determining a geometrical property of the first mould, a geometrical property of a moulded part may be used for adjusting the first mould, so as to bring the geometrical property of the moulded part to be within the acceptable limit. Either the determined geometrical property of the mould or the moulded part, or both the geometrical property of the mould and the moulded part may be used as a basis for adjusting the first mould. It may be an advantage to adjust the first mould using a geometrical property which is indirectly related to the shape of the first mould, such as the geometrical property of a moulded part, since this may compensate both shape deviations of the mould itself and shape deviations of moulded part caused by other effects, residual tensions and further processing of the moulded part. Such further processing may include the process of joining one moulded blade half with another moulded blade half to form a final blade, where the joining process may affect the shape of the blade parts. Also during moulding, the curing of the blade part may affect the shape due to shrinkage. Accordingly, by use of the determined shape properties of the moulded part alone or in combination with shape properties of the mould, it may be possible to minimise deviations of the desired geometrical properties and the actual geometrical properties, since mould imperfections and other shape affecting factors can be compensated adaptively.

A combination of geometrical properties of the first mould and geometrical properties of the moulded part may be achieved for example by adding a percentage of determined shape deviations of the moulded part with determined shape deviations of the mould and comparing this combined shape deviation with the desired shape to determine an adjustment of the mould. The percentage of the determined shape deviation may be based on experimentally obtained values.

It is an advantage of the invention that the mould needs not be manufactured to the final and narrow tolerances required for making wind turbine generator rotor blades, but adjustment to desired geometrical properties can be carried out according to determined geometrical properties and desired tolerances. This ensures that rotor blades can be produced with desired geometrical and aerodynamic properties and with narrow tolerances. Also, the mould can be made lighter whereby it will be less costly and easier to move and to manipulate.

It may be seen as a further advantage, that the method for making a mould enables adjustment of the shape of the mould to desired geometrical properties during the entire lifetime of the mould. Thus, the method may even extend the lifetime of a mould before its replacement is required since degradations of the mould arising due to continued used may be compensated for.

Thus, it may be seen as an advantage that the optimum set-point, i.e. the optimum shape of the mould as required prior to moulding a blade-part, may be achievable so that substantially identical shapes of moulded blade-parts are repeatedly obtainable during the lifetime of the mould. In this way it may be possible to manufacture rotor blades having the same desired aerodynamic characteristics. The optimum shape may be determined from a geometrical property of the first mould and/or a moulded part from the first mould.

In an embodiment the invention comprises measuring the first mould and/or the moulded part to determine the geometrical property of the first mould and/or the moulded part. It will then be determined whether the determined geometrical property of the first mould, alternatively or additionally of the moulded part, is within an acceptable limit, and if not, the first mould will be adjusted so as to bring the geometrical property or properties to be within the acceptable limit. Thus, adjustment of the mould may be performed subsequent to measuring the geometrical property of the moulded part so that an adjustment of the first mould is determined based on the geometrical property, where the adjustment is determined to be suitable for bringing the geometrical property of the moulded part to be within the acceptable limit. The subsequent adjustment then comprises adjusting of the first mould using the determined adjustment.

The geometrical properties of the moulded part may be measured by surface measurements of the outer surface of a first moulded blade shell half after it has been joined with a second moulded blade shell half into the final blade assembly. Joining of the two shells may additionally comprise fixation of a spar between the two shells. Measuring the geometrical property of the moulded part after the assembly with other parts may advantageously imply that shape imperfections caused by the assembly process can be compensated for by mould adjustments—for the subsequent moulded part or parts. The measuring of the moulded part may take place before grinding and painting or after grinding and painting of the blade.

Alternatively, measuring of the moulded part may take place before assembly with other components, for example by measuring surface positions of the inner surface of the blade shell when it is still located in the mould.

In an embodiment the invention comprises determining an adjustment of the first mould suitable for bringing the geometrical property of the moulded part to be within the acceptable limit; where the adjusting of the first mould comprises using the determined adjustment. Thus, the adjustment of the first mould may be determined based on experimental experience or analytical derivations so that the geometrical property of the moulded part or the assembly of the moulded part with other components is within the acceptable limit.

In an embodiment of the invention the support includes
a support bracket fixed to the mould at a support site of the mould, the support bracket having a through-going hole,
a threaded shaft connected to a support structure and protruding through the through-going hole of the support bracket,
engagement means connecting the threaded shaft to the support bracket so as to enable displacement of the support bracket relative to the threaded shaft,

and the method for making a mould comprises,
adjusting the first mould includes adjusting the engagement means so as to secure the support bracket at a desired position relative to the threaded shaft.

Use of an engagement means connecting a threaded shaft to the support bracket for adjusting the position of the support bracket may be seen as an advantageous simple and reliable mechanical construction for allowing adaptive adjustments of the mould. The engagement means may be realised in different ways. For example, the engagement means may comprise a pair of nuts on the threaded shaft and a portion of the support bracket between the pair of nuts, where one or both nuts are used to adjust the position of the support bracket. As another example, the engagement means may comprise an inner thread formed in a through-going hole of the support bracket so that the inner thread matches with the threaded shaft and, thereby, enables adjustment of the position of the support bracket.

### BRIEF DESCRIPTION OF THE DRAWINGS

FIG. 1 show schematically the cross-section of a mould for a half-shell of a wind turbine generator rotor blade being adjusted by a method according to the invention;

FIG. 2 shows a device for use in the method of the invention; and

FIG. 3 shows an alternative device for use in the method of the invention.

### DETAILED DESCRIPTION OF THE INVENTION

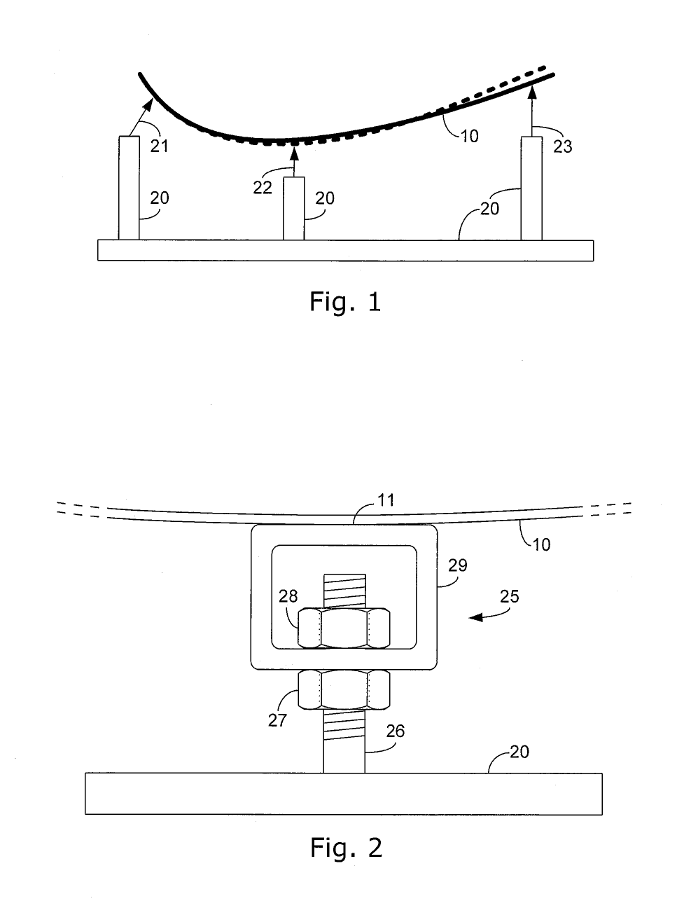

In FIG. 1 is shown a cross-section of a mould 10 for moulding a half-shell of a wind turbine generator rotor blade (not shown). Supports 21, 22, 23 on a frame 20 or other suitable support structure, support the mould 10 at individual support sites. Some or all of the supports 21, 22, 23 are adjustable as will be explained in more detail below.

With the mould 10 supported by the supports 21, 22, 23 on the frame 20 one or more selected geometrical properties of the mould are determined. The selected geometrical properties can include absolute and/or relative coordinates of one or more points of at least a portion of a surface of the mould, e.g. related to the cross-section or a longitudinal section of the mould, or the shape or profile of the cross-section or a longitudinal section of the mould, or the shape of the entire mould or one or more portions thereof. Suitable methods for determining the geometrical properties are known but contact-free methods using e.g. laser scanning are particularly useful.

When the one or more geometrical properties of the mould have been determined they are compared to the corresponding predetermined desired geometrical properties. Each geometrical property that is determined should be within one or more acceptable limits, and for each geometrical property an interval of acceptable geometrical properties about the desired geometrical properties may be defined. If a determined geometrical property is within the acceptable limits, no further action is taken in relation to that geometrical property. If a determined geometrical property is not within the acceptable limits correction is performed as follows.

Likewise, a moulded part of a wind turbine rotor blade or an entire rotor blade assembled from the moulded part can be measured to determine its geometrical properties. Possible deviations from desired geometrical properties can then form the basis for determining corresponding adjustments of the mould that will accommodate for the observed deviations, so that the geometrical properties of subsequently moulded parts will be within acceptable limits.

An acceptable limit is understood as a mechanical tolerance of the mould and/or the moulded part which the determined geometrical properties such satisfy. The acceptable limit may be a predetermined value or range of minimum and maximum values determined from computer simulations or experiments aiming at optimising certain aerodynamic properties, such as aerodynamic efficiency of the blade.

In FIG. 1 the three supports 21, 22, 23 are shown schematically as arrows, and the supports can be adjusted individually to different heights above the frame 20. FIG. 1 illustrates the situation where the determined geometrical property is the profile of the mould 10 and the profile needs adjustment. At support 22 the mould is drawn towards the frame 20, and at support 23 the mould is lifted or pushed away from the frame 20, whereas the support 21 is not changed. The full line illustrates the determined geometrical property being the profile of the mould, and the dashed line illustrates the adjusted profile.

FIG. 2 shows an example of an adjustable support 25 for the mould 10. A threaded shaft 26 is fixedly connected to the support structure or frame 20 which may be fixed to a floor and designed to carry the mould 10. A support bracket 29 has a through-going hole through which the threaded shaft 26 is passed, and two nuts 27, 28 are screwed onto the threaded shaft 26 with a portion of the support bracket between the nuts. The support bracket 29 is fixed to the mould 10 at a support site 11 of the mould.

When the mould 10 needs adjustment relative to the frame 20 the nuts 27, 28 are loosened and adjusted to lower or raise the support bracket 29 as required so as to change the position of the support site. When the desired geometrical property has been achieved the two nuts 27, 28 are tightened against the support bracket so as to secure the support bracket at a desired position relative to the threaded shaft and to fix the mould and to retain its thus adjusted geometrical property. Thus, the combination of the nuts 27, 28 with the threaded shaft 26 and the support bracket constitutes an engagement means connecting the threaded shaft to the support bracket so as to enable displacement of the support bracket relative to the threaded shaft or, equivalently, relative to the support structure 20.

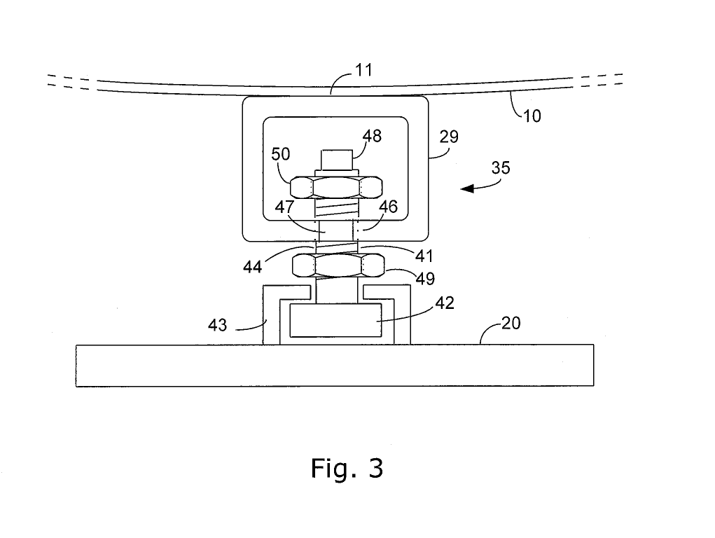

FIG. 3 shows another example of an adjustable support 35 for the mould 10. A threaded shaft 44 is rotatably connected to the support structure or frame 20. For example, the rotatable connection of the threaded shaft 44 to the frame may be enabled by a spindle 41 comprising a threaded shaft portion 44 and a spindle head 42 connected to the frame 20 with the head 42 rotatably engaging with a matching spindle holding means 43 of the frame 20. The spindle holding means 43 may be formed as a groove, a T-slot, or other holding means 43 allowing the spindle 41 to rotate about its longitudinal axis while fixing or restraining displacements of the spindle in direction of the longitudinal axis of the spindle.

The spindle comprises a threaded shaft portion 44 extending in the longitudinal direction of the spindle. The outer threaded portion 44 matches with a corresponding inner thread 46 formed in a through-going hole 47 in the support bracket 29. Thus, the combination of the outer threaded portion 44 and the inner thread 46 constitutes an engagement means connecting the threaded shaft to the support bracket so as to enable displacement of the support bracket relative to the threaded shaft. The support bracket 29 is fixed to the mould 10 at a support site 11 of the mould.

By inserting the head 42 into the holding means 43 and screwing the outer threaded portion 44 into the thread 46 of through-hole 47, the support site 11 of mould 10 can be adjusted towards or away from the frame 20 for adjusting the shape of the mould by rotating the spindle 41 about its longitudinal axis. Rotation of the spindle can be achieved by means of key (not shown) shaped to engage with a shaped portion 48, e.g. an end-portion 48 formed on one of the ends of the spindle 41.

When the desired adjustment of the mould has been achieved, rotation of the spindle 41 can be locked by tightening either nut 49 or nut 50 against the support bracket 29. Optionally, both nuts 49 and 50 could be tightened. Thus, either one, or both of nuts 49 and 50 are provided on the threaded portion 44—and on adjacent sides of the through-hole 47 when two nuts are used.

In the examples in FIGS. 2 and 3, the adjustable support 25, 35 could be arranged in an opposite way so that the support bracket is connected to the frame 20 and the threaded shaft 26 or the head 42 is connected to the mould 10.

Other types of adjustable supports may be used such as electrically or hydraulically operated supports.

When the geometrical properties of the mould have been determined a computer may advantageously be used for calculating adjustments of each support to be carried out in order to bring the geometrical properties of the mould within acceptable limits. A computer may also be used for activating electrically or hydraulically operated supports whereby parts of the process of adjusting the mould or possibly the entire process can be performed automatically.

1. A method for making a mould for a part of a wind turbine rotor blade to be moulded in the mould, comprising:
providing a first mould;
determining whether a geometrical property of the first mould and/or a moulded part from the first mould is within an acceptable limit;
and if the determined geometrical property is not within the acceptable limit
adjusting the first mould so as to bring the geometrical property to be within the acceptable limit.

2. The method of claim 1 further comprising:
measuring the first mould and/or the moulded part to determine the geometrical property of the first mould and/or the moulded part.

3. The method of claim 1 further comprising:
determining an adjustment of the first mould suitable for bringing the geometrical property of the moulded part to be within the acceptable limit;
where the adjusting of the first mould comprises using the determined adjustment.

4. The method of claim 1 wherein the geometrical property includes coordinates of a point.

5. The method of claim 1 wherein the geometrical property includes a profile of a cross-section.

6. The method of claim 1 wherein the geometrical property includes a geometry of at least a portion of a surface.

7. The method of claim 1 wherein the part of a wind turbine rotor blade to be moulded is at least a part of the outer shell of the rotor blade.

8. The method of claim 1 wherein adjusting the first mould includes adjusting a support fixed to a support site of the mould so as to change the position of the support site.

9. The method of claim 1 wherein adjusting the first mould includes adjusting a plurality of supports fixed to respective support sites so as to change the positions of the support sites.

10. The method of claim 8, wherein the support further comprises:
a support bracket fixed to the mould at a support site of the mould, the support bracket having a through-going hole;
a threaded shaft connected to a support structure and protruding through the through-going hole of the support bracket;
an engagement connecting the threaded shaft to the support bracket so as to enable displacement of the support bracket relative to the threaded shaft, and
wherein the method step of adjusting the first mould includes adjusting the engagement so as to secure the support bracket at a desired position relative to the threaded shaft.

11. The method of claim 10, wherein the engagement comprises a pair of nuts on the threaded shaft and a portion of the support bracket between the pair of nuts.

12. The method of claim 10, wherein the engagement comprises an inner thread formed in the through-going hole, and where the inner thread matches with the threaded shaft.

13. The method of claim 10, wherein the threaded shaft is connected to the support structure with a spindle head rotatably engaging with a matching spindle holder of the support structure, or wherein the threaded shaft is fixed to the support structure.

14. The method of claim 1, wherein adjusting the first mould includes adjusting a support fixed to a support site of the mould so as to change the position of the support site, and wherein the support includes
a support bracket fixed to the mould at a support site of the mould, the support bracket having a through-going hole;
a threaded shaft fixed to a support structure and protruding through the through-going hole of the support bracket;
a pair of nuts on the threaded shaft and a portion of the support bracket between the pair of nuts;
and
wherein the method step of adjusting the first mould includes adjusting the pair of nuts so as to secure the support bracket at a desired position relative to the threaded shaft.
